(19) United States
(12) Patent Application Publication
(10) Pub. No.: US 2024/0113895 A1
(43) Pub. Date: Apr. 4, 2024

(54) NFT Minting Method And Apparatus With Digital Certificate-Based Role Authentication And NFT Role Verifying Method And Apparatus

(71) Applicant: Supersymmetry Pte. Ltd, Singapore (SG)

(72) Inventors: Yin Wang, Shanghai (CN); Dinghao Zeng, Shanghai (CN); Zhi Yang, Shanghai (CN); Caihong Wu, Shanghai (CN)

(21) Appl. No.: 18/048,463

(22) Filed: Oct. 21, 2022

Related U.S. Application Data
(63) Continuation of application No. PCT/CN2022/123460, filed on Sep. 30, 2022.

(51) Int. Cl. H04L 9/32; H04L 9/00

(52) U.S. Cl. CPC H04L 9/3263; H04L 9/3247; H04L 9/50

(57) ABSTRACT

A method and an apparatus for minting an NFT, as well as a method and an apparatus for verifying a role associated with an NFT are disclosed. The method for minting an NFT includes: acquiring metadata of an NFT to be minted, where the metadata includes a role type of each of at least one role associated with the NFT to be minted and a common name corresponding to the role type; signing the metadata, by each of the at least one role, using a private key that corresponds to a public key contained in a digital identity certificate of the role, to obtain a signature by the role; and minting an NFT on chain based on the metadata. As such, the authenticity of information in the metadata can be verified by the signatures.

### CROSS-REFERENCE TO RELATED APPLICATIONS

This application is a continuation of PCT Application No. PCT/CN2022/123460 filed on Sep. 30, 2022. The entire disclosure of the above application is incorporated herein by reference.

### TECHNICAL YIELD

The present disclosure relates to the field of NFT (Non-Fungible Token) technologies, and particularly to digital certificate-based authentication for roles associated with an NFT, and more particularly to a method and an apparatus for minting an NFT, as well as a method and an apparatus for verifying a role associated with an NFT.

### BACKGROUND

An NFT is an asset consisting of digital data stored in a blockchain, and the ownership of the NFT is recorded in the blockchain but can be transferred by an owner of the NFT, allowing the NFT to be traded. What an NFT represents is dictated and governed by the smart contract where the NFT is minted.

However, due to the absence of an authentication mechanism associated with the minting of an NFT, the authenticity of the minted NFTs cannot be verified, as a result, the value of the NFTs cannot be credibly determined, and the circulation of the NFTs on the market may be impacted.

### SUMMARY

Therefore, embodiments of the present invention at least provide a method and an apparatus for minting an NFT, as well as a method and an apparatus for verifying a role associated with an NFT, to verify the authenticity of the minted NFT by using a signature by the role.

In a first aspect, provided is a method for minting an NFT, which includes:
acquiring metadata of an NFT to be minted, where the metadata includes a role type of each of at least one role associated with the NFT to be minted and a common name corresponding to the role type,
signing the metadata, by each of the at least one role, using a private key that corresponds to a public key contained in a digital identity certificate of the role, to obtain a signature by the role, and
minting an NFT on chain based on the metadata.

In an embodiment, the signature by each of the at least one role may be accessible via the metadata, either directly or indirectly, or the signature may be provided on demand.

In an embodiment, the role type includes at least one of an author and a publisher of the NFT to be minted.

In an embodiment, the digital identity certificate of the role or a Uniform Resource Locator (URL) address corresponding to the digital identity certificate is included in the metadata.

In an embodiment, an on-chain account address of one or more of the at least one role is included in the metadata.

In an embodiment, the metadata includes a smart contract address configured to identify a smart contract under which the NFT can be minted.

In an embodiment, the metadata includes a minter address configured to identify a minter qualified for minting the NFT to be minted.

In an embodiment, the metadata includes a pre-determined NFT token ID configured to uniquely identify the minted NFT.

In an embodiment, in signing the metadata by each of the at least one role using the private key, the at least one role signs the metadata concurrently, or in a random order or sequentially in a predefined order.

In an embodiment, in signing the metadata, the metadata is fully or partially signed.

In an embodiment, when a part of the metadata is signed, the part of the metadata includes the role type and the common name, as well as at least one of the digital identity certificate of the role, the Uniform Resource Locator address corresponding to the digital identity certificate, the on-chain account address of one or more of the at least one role, the smart contract address, the minter address and the pre-determined NFT token ID.

In an embodiment, the digital identity certificate of the role is a Certificate Authority (CA) signed certificate which is returned to the role by a CA in response to a Certificate Signing Request (CSR) from the role.

In an embodiment, the signature by each of the at least one role is combined with the metadata, or an access address of the signature by each of the at least one role is included in the metadata.

In a second aspect, provided is a method for verifying a role associated with an NFT, including:
obtaining an NFT on chain,
acquiring metadata of the NFT based on the NFT, where the metadata includes a role type of each of at least one role associated with the NFT and a common name corresponding to the role type,
acquiring a digital identity certificate of each of the at least one role and a signature of the metadata by the role, and
verifying the signature of the metadata by the role by using the digital identity certificate of the role, and determining that the role type and the corresponding common name included in the metadata are authentic if the verification succeeds.

In a third aspect, provided is an apparatus for minting an NFT including:
an acquiring module configured to acquire metadata of an NFT to be minted, where the metadata includes a role type of each of at least one role associated with the NFT to be minted and a common name corresponding to the role type,
a signing module configured to allow each of the at least one role to sign the metadata by using a private key that corresponds to a public key contained in a digital identity certificate of the role, to obtain a signature by the role; and
a minting module configured to mint an NFT on chain based on the metadata.

Here, the signature by each of the at least one role may be accessible via the metadata, either directly or indirectly, or the signature may be provided on demand.

In a fourth aspect, provided is an apparatus for verifying a role associated with an NFT, including:
a first obtaining module configured to obtain an NFT on chain, and obtain metadata of the NFT based on the NFT, where the metadata includes a role type of each of at least one role associated with the NFT and a common name corresponding to the role type,
a second obtaining module configured to acquire a digital identity certificate of each of the at least one role and a signature of the metadata by the role, and
a verifying module configured to verify the signature of the metadata by the role by using the digital identity certificate of the role, and to determine that the role type and the corresponding common name included in the metadata are authentic if the verification succeeds.

In a fifth aspect, provided is an electronic device including a processor, a storage device and a bus, where the storage device is stored with machine-readable instructions executable by the processor, the processor is in communication with the storage device via the bus when the electronic device operates, and the machine-readable instructions, when executed by the processor, perform the method for minting an NFT in the above first aspect or any embodiment thereof or the method for verifying a role associated with an NFT in the above second aspect any embodiment thereof.

In a sixth aspect, provided is a computer readable storage medium stored with a computer program, which, when executed by a processor, performs the method for minting an NFT in the above first aspect any embodiment thereof or the method for verifying a role associated with an NFT in the above second aspect any embodiment thereof.

With the above method and apparatus for minting an NFT, as well as the method and apparatus for verifying a role associated with an NFT, the acquired metadata of the NFT to be minted is signed by each of the at least one role using a private key that corresponds to a public key contained in a digital identity certificate of the role, to obtain a signature by the role, and then an NFT is minted on chain based on the metadata. In the present disclosure, the information related to the roles of the NFT to be minted may be contained in the metadata, so that the metadata can be signed by the roles. After the NFT is minted based on the metadata, the signatures of the related roles may be accessed via the metadata or provided on demand and verified for the authenticity of information contained in the metadata of the minted NFT. Particularly, the case in which the signature passes the verification indicates that the metadata of the NFT is authentic, and the case in which the signature fails to pass the verification indicates that the authenticity of the metadata of the NFT cannot be confirmed. In this way, the verification of the authenticity of a target NFT is facilitated so that anyone can verify the authenticity of the NFT, thereby providing a solid basis for determining the value of the NFT, and thus improving the circulation of the NFT with authentic metadata on market.

Other advantages of the present disclosure will be described in detail with reference to the accompanying drawings.

It should be noted that the aforesaid description only shows a summary of the technical solutions of the present disclosure to facilitate better understanding of technical means of the present disclosure for implementing the present disclosure in accordance with the content described in the specification. Specific embodiments of the present disclosure will be given below to make the above and other objects, features, and advantages of the present disclosure more apparent.

### BRIEF DESCRIPTION OF THE DRAWINGS

By reading following details of the exemplary embodiments below, those of ordinary skills in the art may understand the advantages and benefits described herein and other advantages and benefits. The accompanying drawings are for the purpose of illustrating exemplary embodiments only and are not intended to limit the present disclosure. Further, a same reference sign is adopted to indicate a same component throughout the accompanying drawings. In the accompanying drawings:

FIG. 1 is a schematic diagram showing the flow of a method for minting an NFT according to an embodiment of the present invention;

FIG. 2 is a schematic diagram showing an application of the method for minting an NFT according to an embodiment of the present invention;

FIG. 3 is a schematic diagram showing the flow of a method for verifying a role associated with an NFT according to an embodiment of the present invention;

FIG. 4 is a schematic diagram showing the flow of an apparatus for minting an NFT according to an embodiment of the present invention;

FIG. 5 is a schematic diagram showing an apparatus for verifying a role associated with an NFT according to an embodiment of the present invention; and

FIG. 6 is a schematic diagram showing an electronic device according to an embodiment of the present invention.

### DETAILED DESCRIPTION

Exemplary embodiments of the present disclosure will be described below in more detail with reference to the accompanying drawings. Although the accompanying drawings illustrate exemplary embodiments of the present disclosure, it should be understood that the present disclosure can be implemented in various forms and should not be construed as being limited to embodiments described herein. Rather, these embodiments are provided so that the present disclosure will be understood thoroughly, and will fully convey the scope of the present disclosure to those skilled in the art.

In the present disclosure, it should be understood that terms such as “include”, “including”, “comprise” and “comprising” are intended to indicate the presence of the characteristics, figures, steps, actions, components and parts disclosed by the specification or any combination thereof, without excluding the presence of one or more other characteristics, figures, steps, actions, components, parts or any combination thereof.

Unless otherwise specified, the symbol “/” refers to “or”, for example, a term “A/B” refers to “A or B”, and a term “A and/or B” refers to the presence of merely A, the presence of merely B, and the presence of both A and B.

Terms “first”, “second” and so on are used to distinguish one feature from other same features, rather than implying or indicating that one of these features is more important than the other ones or implying the number of the features.

Furthermore, it should be noted that, in the case of no conflict, the embodiments of the present invention and features of the embodiments may be combined with each other in any manner. The present disclosure will be described in detail below with reference to the accompanying drawings and embodiments.

As described above, the NFT is an asset consisting of digital data stored in a blockchain, and the ownership of the NFT is recorded in the blockchain but can be transferred by an owner of the NFT, allowing the NFT to be traded. What an NFT represents is dictated and governed by the smart contract where the NFT is minted.

However, due to the absence of an authentication mechanism associated with the minting of an NFT, the authenticity of the minted NFTs cannot be verified, as a result, the value of the NFTs cannot be credibly determined, and the circulation of the NFTs on the market may be impacted.

Herein, the authenticity of the minted NFTs refers to the authenticity of roles associated with the NFTs and the authenticity of information related to the roles. To further illustrate the problems existing in the prior art, further description is given below in combination with some common roles.

Besides the owner of an NFT, there may be other roles associated with the NFT, for example, an NFT author that refers to an individual or organization who created what the NFT represents (which is also called herein as works represented by the NFT, for the sake of convenience), and an NFT publisher that refers to an individual or organization under which the NFT was published. In the case that the works represented by an NFT is an art, the NFT author is an artist. In addition, the NFT publisher usually deploys and manages the smart contract where the NFT is minted.

The value of an NFT is usually determined by the works represented by the NFT, the author of the NFT, and the publisher of the NFT who manages the smart contract where the NFT was minted. For example, in the case that an NFT is minted for a painting and a famous painter is named as the NFT author, the authenticity of the NFT author decides the value of the NFT. Particularly, the NFT is valuable only if the NFT author is authentic, i.e., the NFT author is recognized as the authentic creator of this painting. Furthermore, if the publisher of the NFT is an individual or organization with authority, the authenticity of the NFT is further recognized if the authenticity of the publisher of the NFT is recognized, thus further raising the value of the NFT.

Therefore, it is essential to prove the authenticity of the author and the publisher of an NFT in order for determining the credible value of the NFT. However, in the prior art, no identity verification mechanism is provided for the NFT author, and the existing verification mechanism for the NFT publisher is unpractical.

Particularly, as for an NFT author, a popular way to associate an NFT with its author is to attach on the blockchain a piece of data where the author's name is simply written down as plain text, so that anyone can query the author when an NFT comes up. This piece of data is usually called metadata of the NFT.

As seen from the above, putting the name or other information of the author into the metadata of the NFT can loosely associate the author with the NFT, but this cannot certify that the author of the NFT indeed created the works represented by this NFT, this is because (1) no identity information is associated with the name or other information of the author put in the metadata; and (2) there is no authorization certificate from the author. For example, in the case of an NFT which was minted for a painting, merely placing the name “Picasso” as the author in the metadata of the NFT cannot prove that this painting represented by the NFT is actually created by the famous Spanish painter Picasso. Actually, even without the authorization from the famous Spanish painter Picasso, anyone may mint an NFT for a famous painting created by the famous Spanish painter Picasso and put “Picasso” as the NFT author in the metadata of this NFT, that is, the publisher of the NFT can still place “Picasso” as the NFT author within the metadata of the NFT when publishing the NFT, as long as the smart contract under which the NFT is minted approves, thus the authenticity of the minted NFT is not ensured.

Additionally, it is difficult for identity verification of an NFT publisher in the prior art because the publisher of an NFT is vaguely conveyed by the address of the smart contract under which the NFT is minted and the address of the smart contract is not human readable, and thus people cannot know the publisher of the NFT directly from the address of the smart contract. There are organizations like OpenSea.io that provide services to authenticate the NFT publisher by displaying on their website the name of the NFT publisher instead of the smart contract address and placing a check mark near the name to indicate its authenticity. As an alternative to the aforementioned naming organizations, an NFT publisher can choose to use the Ethereum Name Service (ENS) to name its address.

Despite the above, implying the NFT publisher via the smart contract address is defective as below.

1. The existing organizations providing naming services for NFT publishers are not authoritative, and the ENS, which is more authoritative, has not been widely deployed and recognized.

2. The role of the publisher of an NFT is highly coupled with the owner of the smart contract under which the NFT is minted, and this is not flexible for a separate publisher that is different from the owner of the smart contract.

To at least partially address one or more of the above and other problems, the present disclosure provides a solution of minting an NFT in which the metadata is signed by at least one role associated with the NFT, thereby improving the authenticity of the minted NFT.

According to an embodiment of the present invention, provided is a method for minting an NFT which may be performed by an electronic device with a computing capability, and the electronic device includes, for example, a terminal device, a server or any other processing devices. Here, the terminal device may be a User Equipment (UE), a mobile device, a user terminal, a computing device and so on. In some possible implementations, the method for minting an NFT may be performed by a processor which invokes computer-readable instructions stored in a storage device.

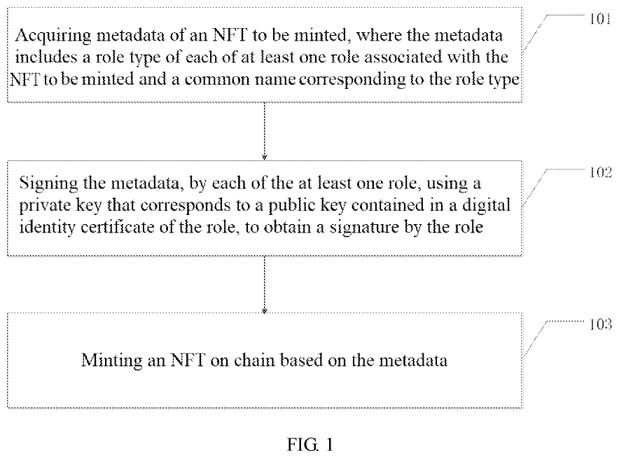

With reference to FIG. 1 which shows a flowchart of a method for minting an NFT according to an embodiment of the present invention, and the method includes:
Step S101 of acquiring metadata of an NFT to be minted, where the metadata includes a role type of each of at least one role associated with the NFT to be minted and a common name corresponding to the role type,
Step S102 of signing the metadata, by each of the at least one role, using a private key that corresponds to a public key contained in a digital identity certificate of the role, to obtain a signature by the role, and
Step S103 of minting an NFT on chain based on the metadata.

Here, the signature by each of the at least one role may be accessible via the metadata, either directly or indirectly, or the signature may be provided on demand.

Although an NFT per se is unique, the authenticity of roles associated with the NFT cannot be verified in the prior art due to the lack of identity verification information of the roles in the metadata of the NFT, resulting in difficulties in determining the value of the NFT. In view of this, a signature by the role is combined in the method for minting an NFT according to the embodiment of the present invention, so that the authenticity of the role of the NFT can be verified using the signature by the role, thereby providing a solid basis for determining the value of the NFT.

As for the NFT to be minted, its metadata needs to contain a role type of the role associated with the NFT to be minted and a common name corresponding to the role type, to enable the verification of the authenticity of the role. There are various role types to which different roles belong, for example, the role types may include an author of the works represented by the NFT and a publisher responsible for deploying the smart contract under which the NFT is minted, as well as other role types involved in minting the NFT, such as a producer, a lyricist, a composer, a director and a scriptwriter. Depending on the type of the works represented by the NFT, the corresponding role type(s) may be varied, and the present disclosure is not limited thereto. The common name corresponding to the role type may refers to a particular role of this role type, for example, if the particular role is an individual, the common name may be a full name of the individual. For example, in the case of an NFT minted for a film entitled “AVATAR” that is directed by the famous film director James Cameron, there is a role type of film director and a corresponding common name of James Cameron.

In a certain application, the metadata may be filled with in advance role types of one or more roles and common names corresponding to the role types, and the number of the roles is not limited herein.

Before the NFT is minted on chain based on the metadata, the metadata is signed by each of the at least one role using a private key that corresponds to a public key contained in a digital identity certificate of the role.

The digital identity certificate, which is an identity certificate of an individual or organization in the cyber world, may be issued by the CA, or retrieved from a certificate library, or obtained otherwise, and the present invention is not limited thereto. Considering that the CA functions as the core of the Public Key Infrastructure (PKI) and is highly authentic, a CA signed certificate may be adopted as the digital identity certificate.

By taking an example where a CA signed certificate is adopted as the digital identity certificate, the step of signing the metadata by the role is described in detail below in combination with processes such as certificate requesting and certificate issuing.

To obtain a digital certificate from the CA, a user firstly sends a request to the CA. The CA verifies the identity of the user and signs the identity information of the user (which contains a public key of the user) using the private key of the CA, so that a digital certificate with the CA's signature is formed and returned to the user.

Like the user, any role in the embodiment of the present invention may obtain a digital certificate signed by the CA following the above processes. Here, the role sends to the CA a Certificate Signing Request (CSR) containing role information and a public key of the role, so that the CA can verify the identity of the role based on the role information.

As seen from the above, the public key of the role is combined in the digital certificate of the role. By using the public key of the CA, anyone may verify the digital certificate of the role, and once the verification succeeds, the digital certificate of the role is recognized, that is, it is proved that the digital certificate is issued by the CA to the role and the public key of the role contained in the digital certificate is authenticated.

For the purpose of signature, the role signs using its private key corresponding to its public key. In the embodiment, for the purpose of the identity authenticity of any role associated with the NFT to be minted, the role signs the metadata of the NFT to be minted. In this way, anyone can verify the signature by the role by using the public key of the role, in order to verify the authenticity of the identity of the role.

After the metadata is signed by one or more roles, an NFT can be minted on chain based on the metadata. In the embodiment, the signature by each of the one or more roles is accessible to anyone via the metadata of the minted NFT either directly or indirectly, or the signature may be provided on demand, so that anyone is enabled to verify the role's signature to confirm the authenticity of the role, thereby providing a reference for anyone in determining the value of the minted NFT. This is advantageous over the existing metadata without any identity verification mechanism for roles.

In embodiments of the present invention, the metadata may be attached to a chain such as the blockchain in various manners of: (1) storing the metadata on the blockchain directly; (2) storing the metadata in a storage service platform such as InterPlanetary File System (IPFS) and storing a Uniform Resource Locator (URL) corresponding to the metadata on the blockchain; (3) storing the metadata on the Internet and storing a URL corresponding to the metadata on the blockchain; and (4) storing the metadata on the Internet and storing a URL corresponding to the metadata as well as a hash value of the metadata on the blockchain, thereby preventing the metadata from being tampered.

Depending on the amount of the metadata, one of the above manners (1) to (4) may be selectively adopted. For example, for the metadata of a small amount, the manner (1) may be adopted to store the metadata directly on the blockchain. For the metadata of a relatively big amount, the manner (3) or (4) may be adopted. Of course, other manners of storing the metadata are possible and the present disclosure is not limited thereto. Along with attaching the metadata to the chain, the NFT is minted on chain, like in the prior art.

In an embodiment, to facilitate the access and subsequent verification of the signature by the role(s), the signature by the role(s) may be combined with the metadata, or an access address of the signature by the role(s) may be included in the metadata, or the signature by the role(s) may be provided on demand, e.g., by the role(s) associated with the NFT or the owner of the NFT. Of course, any other manner of accessing the signature by the role(s) may be adopted, and the present disclosure is not limited thereto.

It should be noted that the metadata may include information other than role information such as the above-mentioned role type and common name.

In an example, to facilitate anyone to verify the signature of the metadata by a role associated with the minted NFT, the digital identity certificate per se of the role may be put into the metadata, so that anyone can obtain the digital identity certificate directly from the metadata and then verify the role's signature using the digital identity certificate. Alternatively, a URL corresponding to the digital identity certificate of the role may be put into the metadata, so that anyone can access and obtain the digital identity certificate via the URL and then verify the role's signature using the obtained digital identity certificate.

In another example, to ensure the authenticity of an on-chain account address of a role associated with an NFT, the account address of the role may be put into the metadata of the NFT. In a blockchain-based network, each user such as an individual or an organization is assigned with a dedicated unique account address, for the purpose of online digital transaction operations, thus the authenticity of the account address is essential. If the on-chain account address of the role is included in the metadata of the NFT, signing the metadata by the role implies that this role recognizes the authenticity of the account address. In this case, after successfully verifying the signature by the role, anyone should not worry about the authenticity of the account address of the role from the metadata signed by the role.

In still another example, a smart contract address may be included in the metadata to identify a smart contract under which the NFT to be minted can be minted. As one of the key technologies, the smart contract can be created for transactions between users. In some cases, it is required to utilize the designated smart contract to mint the NFT. To this end, the address of the designated smart contract may be added to the metadata, so that the NFT to be minted is allowed to be minted under only the smart contract having this address.

In still another example, it is possible to designate unique role(s) in the metadata. For example, the metadata may include a minter address configured to identify a unique minter qualified for minting the NFT to be minted, thus excluding other minters from minting this NFT.

In still another example, the metadata may include a pre-determined NFT token ID configured to uniquely identify the minted NFT, so that the consequently minted NFT has the pre-determined NFT token ID.

It shall be noted that anyone or any combination of the above-mentioned information may be added to the metadata according to embodiments of the invention. Further, other additional information may be added to the metadata as desired, and the present disclosure is not limited thereto.

According to an embodiment, in the case of a plurality of roles associated with the NFT to be minted, the roles may sign the metadata of the NFT concurrently, or in a random order or sequentially in a predefined order. The predefined order may depend on the importance of the respective roles. For example, in the case where the works represented by the NFT is a film and there are three roles including a film director, a film composer and a publisher associated with the NFT, typically the film director is more important than the film composer, the metadata may be signed by these three roles in an order of the film director, the film composer and the publisher.

In an embodiment, the signature order of the roles may be defined by descriptive information in the metadata. Alternatively, the roles may sign the metadata in an order scheduled by a coordinator, but the present disclosure is not limited thereto.

In an embodiment, in signing the metadata, the metadata may be fully or partially signed. Signing the metadata fully by a role, i.e., signing the whole contents of the metadata by the role, indicates that this role recognizes the whole contents of the metadata. Likewise, signing the metadata partially by a role, i.e., signing a part of the metadata by the role, indicates that this role recognizes the partial contents of the metadata. Here, the partial contents of the metadata may include contents related to the role, and/or other contents essential for minting the NFT, but the present disclosure is not limited thereto.

In an embodiment, when a part of the metadata is signed, the part of the metadata may include the role type and the common name, as well as at least one of the digital identity certificate of the role, the Uniform Resource Locator address corresponding to the digital identity certificate, the on-chain account address of one or more of the at least one role associated with the NFT to be minted, the smart contract address, the minter address and the pre-determined NFT token ID.

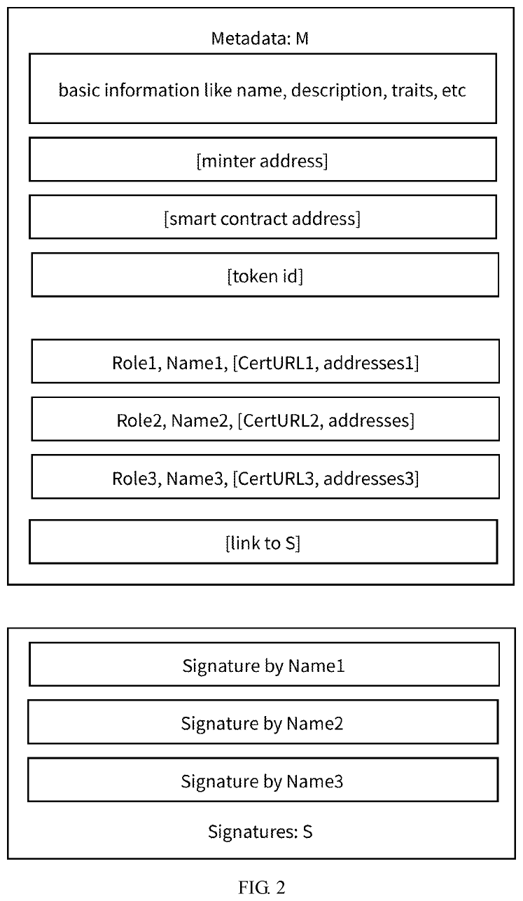

For better understanding of the method for minting an NFT according to the embodiment of the present invention, a case in which a plurality of roles associated with the NFT are present is illustratively described below in combination with FIG. 2.

In this case, there are three roles associated with an NFT to be minted, these three roles are of three different role types of Role1, Role2 and Role3, respectively, and have their respective names of Name1, Name2 and Name3. Here, each of the roles has acquired in advance a digital certificate from the CA to certify the identity thereof. The digital certificate of a role is publicly available and contains the public key of the role.

When the digital certificate of each of the roles is ready, the minting of the NFT may begin, as illustrated in the below steps.

1. Metadata M of the NFT to be minted is prepared, where the metadata M may contain NFT basic information like name, description and possibly other required resources like an image URL. In addition, for each of the roles associated with the NFT, a role type and a corresponding common name of the role are contained in the metadata M. For example, if the NFT author is Leonardo, then the corresponding role information of the NFT author may be described as [Author, Leonardo]. If there are N roles, there are N pieces of this kind of role information. Among of all, two important roles associated with the NFT are NFT author and NFT publisher. In the example shown in FIG. 2, N is 3.

The metadata M may optionally further include a URL of the digital certificate of each of the roles. Though the digital certificates are publicly available, putting their URLs into the metadata M makes them more accessible.

The metadata M may optionally further include a blockchain address of any of the roles if the role happens to own the blockchain address, to prove that the blockchain address is indeed owned by this role.

Additionally, the metadata M may optionally further include a smart contract address, so that the NFT can only be minted under a specific smart contract approved by the roles who signed the metadata M, i.e., a smart contract having the smart contract address contained in the metadata M.

The metadata M may optionally further include a minter address, so that the minter can be limited to a specific one approved by the roles who signed the metadata M, i.e., the minter with the minter address contained in the metadata M.

The metadata M may optionally further include an NFT token ID, so that the consequently minted NFT associated with the metadata M is guaranteed to be a unique one that is approved by the roles who signed the metadata M, i.e., an NFT having the NFT token ID contained in the metadata M.

2. The metadata M, which includes the basic information, the roles' information and the extra optional information mentioned above, is sent to each of the roles for signature. The signatures by the roles can be done parallelly or sequentially, where the order doesn't matter.

3. Upon receiving the metadata M, each of the roles uses its private key to sign the metadata M to obtain a signature of the metadata M by the role. The private key of the role corresponds to the public key of the role contained in the digital certificate of the role. If there are N roles, there will be N signatures. In the case shown in FIG. 2, there are 3 roles and hence there are 3 signatures by these roles, and a set of these 3 signatures are labelled as S.

4. Then whoever responsible for minting the NFT mints the NFT, with the metadata M being associated with the NFT token ID. The metadata M and the set of signatures S may be stored somewhere that is accessible by the public, either on blockchain or off blockchain. The set of signatures S may be stored in such a way that, given the metadata M, the public can easily find the set of signatures S. One way to do this is to embed the URL of the set of signatures S into the metadata M. Another way is to combine the metadata M and the set of signatures S and store them together.

In step 4, if the metadata M is stored off chain, a hash function like SHA256 can be adopted to generate a hash value from the metadata M, and the hash value is stored on the blockchain, so that the immutability of the metadata M is guaranteed.

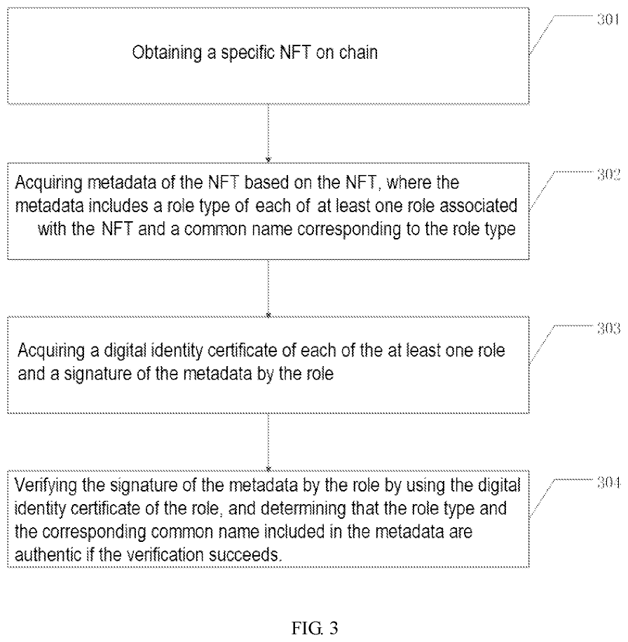

As shown in FIG. 3, according to the above-described method for minting an NFT, an embodiment of the present invention provides a method for verifying a role associated with an NFT, which includes:
Step S301 of obtaining a specific NFT on chain,
Step S302 of acquiring metadata of the NFT based on the NFT, where the metadata includes a role type of each of at least one role associated with the NFT and a common name corresponding to the role type,
Step S303 of acquiring a digital identity certificate of each of the at least one role and a signature of the metadata by the role, and
Step S304 of verifying the signature of the metadata by the role by using the digital identity certificate of the role, and determining that the role type and the corresponding common name included in the metadata are authentic if the verification succeeds.

As seen from the above, to verify the authenticity of a target role associated with a specified NFT, the digital identity certificate of the role and the signature of the metadata by the role are acquired, so that the signature of the metadata by the role may be verified using the digital identity certificate (particularly the public key in the digital identity certificate) of the role. If the verification succeeds, the authenticity of the identity of the target role is proved.

In the flows of the methods provided in the embodiments, some operations are described as various steps performed in a certain order. These flows are illustrative but not limitative. For example, some of the steps may be grouped together and performed within a single operation, or may be divided into a plurality of sub-steps, or may be performed in an order different from that as described herein. The various steps in the flows may be performed by a circuitry and/or other tangible mechanisms (for example, software running on a computing device, hardware such as a processor or a logic function implemented by a chip, and/or any combination thereof.

Like the conception of the above-described methods, an embodiment of the present invention provides apparatuses corresponding to the above methods. Because the principle of the apparatuses for addressing the problems according to the embodiment is similar to that of the methods, reference may be made to the description of the corresponding method and duplicated description will not be repeated hereinafter.

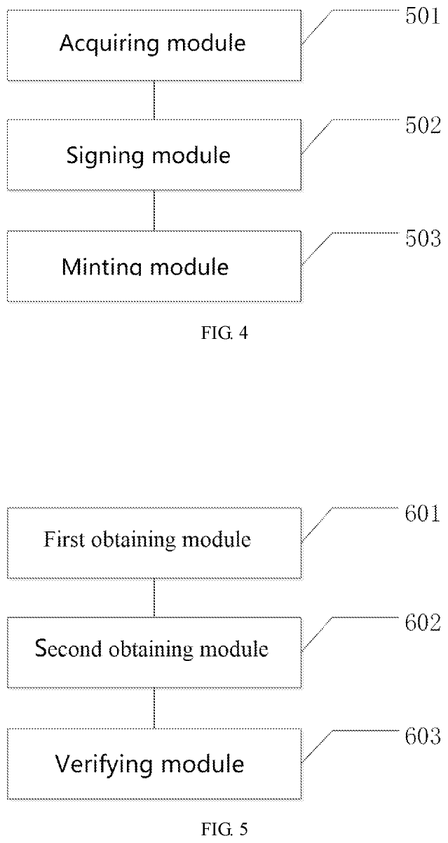

Reference is now made to FIG. 4 which is a schematic diagram showing an apparatus for minting an NFT according to an embodiment of the invention, and the apparatus includes an acquiring module 501, a signing module 502 and a minting module 503.

The acquiring module 501 is configured to acquire metadata of an NFT to be minted, where the metadata includes a role type of each of at least one role associated with the NFT to be minted and a common name corresponding to the role type.

The signing module 502 is configured to allow each of the at least one role to sign the metadata by using a private key that corresponds to a public key contained in a digital identity certificate of the role, to obtain a signature by the role.

The minting module 503 is configured to mint an NFT on chain based on the metadata.

Here, the signature by each of the at least one role is accessible via the metadata, either directly or indirectly, or the signature may be provided on demand.

With the above apparatus for minting an NFT, the acquired metadata of the NFT to be minted is signed by each of the at least one role using a private key that corresponds to a public key contained in a digital identity certificate of the role, to obtain a signature by the role, and then an NFT is minted on chain based on the metadata. In the present disclosure, the information related to the roles of the NFT to be minted may be contained in the metadata, so that the metadata can be signed by the roles. After the NFT is minted based on the metadata, the signatures of the related roles may be accessed and verified for the authenticity of information contained in the metadata of the minted NFT. Particularly, the case in which the signature passes the verification indicates that the metadata of the NFT is authentic, and the case in which the signature fails to pass the verification indicates that the authenticity of the metadata of the NFT cannot be confirmed. In this way, the verification of the authenticity of a target NFT is facilitated so that anyone can verify the authenticity of the NFT, thereby providing a solid basis for determining the value of the NFT, and thus improving the circulation of the NFT with authentic metadata on market.

In an embodiment, the role type includes at least one of an author and a publisher of the NFT to be minted.

In an embodiment, the digital identity certificate of the role or a URL address corresponding to the digital identity certificate is included in the metadata.

In an embodiment, an on-chain account address of one or more of the at least one role is included in the metadata.

In an embodiment, the metadata includes a smart contract address configured to identify a smart contract under which the NFT to be minted can be minted.

In an embodiment, the metadata includes a minter address configured to identify a minter qualified for minting the NFT to be minted.

In an embodiment, the metadata includes a pre-determined NFT token ID configured to uniquely identify the minted NFT.

In an embodiment, in signing the metadata by each of the at least one role using the private key, the signing module 502 is further configured to allow the at least one role to sign the metadata concurrently, or in a random order or sequentially in a predefined order.

In an embodiment, the signing module 502 is further configured to, in signing the metadata, enable the metadata to be fully or partially signed.

In an embodiment, when a part of the metadata is signed, the part of the metadata includes the role type and the common name, as well as at least one of the digital identity certificate of the role, the Uniform Resource Locator address corresponding to the digital identity certificate, the on-chain account address of one or more of the at least one role, the smart contract address, the minter address and the pre-determined NFT token ID.

In an embodiment, the digital identity certificate of the role is a CA signed certificate which is returned to the role by a CA in response to a CSR from the role.

In an embodiment, the signature by each of the at least one role is combined with the metadata, or an access address of the signature by each of the at least one role is included in the metadata.

Reference is now made to FIG. 5 which is a schematic diagram showing an apparatus for verifying a role associated with an NFT according to an embodiment of the invention, and the apparatus includes a first obtaining module 601, a second obtaining module 602, and a verifying module 603.

The first obtaining module 601 is configured to obtain an NFT on chain and obtain metadata of the NFT based on the NFT, where the metadata includes a role type of each of at least one role associated with the NFT and a common name corresponding to the role type.

The second obtaining module 602 is configured to acquire a digital identity certificate of each of the at least one role and a signature of the metadata by the role.

The verifying module 603 is configured to verify the signature of the metadata by the role by using the digital identity certificate of the role, and to determine that the role type and the corresponding common name included in the metadata are authentic if the verification succeeds.

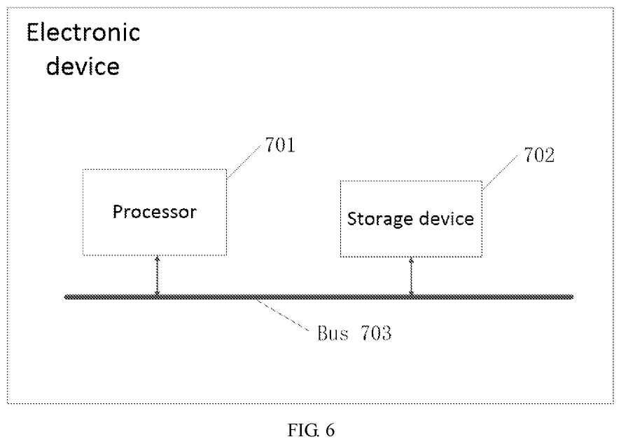

An embodiment of the present invention further provides an electronic device, a schematic structure of which is shown in FIG. 6. The electronic device includes a processor 701, a storage device 702, and a bus 703. The storage device 702 is stored with machine-readable instructions (for example, instructions executed by the acquiring module 501, the signing module 502 and the minting module 503 of the apparatus shown in FIG. 4, and instructions executed by the first obtaining module 601, the second obtaining module 602, and the verifying module 603 of the apparatus shown in FIG. 5) executable by the processor 701. The processor 701 is in communication with the storage device 702 via the bus 703 when the electronic device operates, and the machine-readable instructions, when executed by the processor 701, perform the method for minting an NFT as shown in FIG. 1 or the method for verifying a role associated with an NFT as shown in FIG. 3.

An embodiment of the invention further provides a computer readable storage medium stored with a computer program, which, when executed by a processor, performs the method for minting an NFT or the method for verifying a role associated with an NFT in the above embodiments. Here, the storage medium may be a volatile or nonvolatile computer-readable storage medium.

An embodiment of the invention further provides a computer program product carrying program codes, and the program codes containing instructions to perform the method for minting an NFT or the method for verifying a role associated with an NFT in the above embodiments.

The above computer program product may be embodied by hardware, software or a combination thereof. In an embodiment, the computer program product is embodied by a computer storage medium, while in another embodiment, the computer program product is embodied by a software product such as a Software Development Kit (SDK).

The above various embodiments of the invention are described in a progressive manner, the description of the successive embodiment emphasizes on parts different from the previous embodiments, and the description of relevant parts may be referred to among the embodiments. Since the embodiments of the apparatuses, the devices and the computer-readable storage medium are like those of the corresponding methods, the description thereof is simplified, and reference may be made to the relevant parts of the embodiments of the methods. However, the apparatuses, the devices and the computer-readable storage medium are likewise advantageous as the corresponding methods.

The computer-readable storage medium may be transient or non-transient, and may be mobile or immobile. Examples of the computer-readable storage medium include, but are not limited to, a Phase Change Random Access Memory (PRAM), a Static Random Access Memory (SRAM), a Dynamic Random Access Memory (DRAM), any other types of Random Access Memories (RAMs), a Read Only Memory (ROM), an Electrically Erasable Programmable Read-Only Memory (EEPROM), a Flash, a Compact Disc Read-Only Memory (CD-ROM), a Digital Video Disk (DVD) or other optical storages, which are adapted to store information accessible by a computing device.

Although the conception and principles of the present disclosure have been described with reference to several embodiments, it shall be understood that the present disclosure is not limited to the embodiments as disclosed, nor does the division of the aspects imply that the features in those aspects cannot be combined for benefit, such division being for convenience of presentation only. The present disclosure is intended to cover various modifications and equivalent arrangements included within the scope of the appended claims.

What is claimed is:

1. A method for minting a Non-Fungible Token (NFT) comprising:
acquiring metadata of an NFT to be minted, wherein the metadata includes a role type of each of at least one role associated with the NFT to be minted and a common name corresponding to the role type,
signing the metadata, by each of the at least one role, using a private key that corresponds to a public key contained in a digital identity certificate of the role, to obtain a signature by the role, and
minting an NFT on chain based on the metadata.

2. The method of claim 1, wherein the role type includes at least one of an author and a publisher of the NFT to be minted.

3. The method of claim 1, wherein the digital identity certificate of the role or a Uniform Resource Locator address corresponding to the digital identity certificate is included in the metadata.

4. The method of claim 1, wherein an on-chain account address of one or more of the at least one role is included in the metadata.

5. The method of claim 1, wherein the metadata includes a smart contract address configured to identify a smart contract under which the NFT to be minted is minted.

6. The method of claim 1, wherein the metadata includes a minter address configured to identify a minter qualified for minting the NFT to be minted.

7. The method of claim 1, wherein the metadata includes a pre-determined NFT token ID configured to uniquely identify the minted NFT.

8. The method of claim 1, wherein in signing the metadata by each of the at least one role using the private key, the at least one role signs the metadata concurrently, or in a random order or sequentially in a predefined order.

9. The method of claim 1, wherein in signing the metadata, the metadata is fully or partially signed.

10. The method of claim 9, wherein the part of the metadata includes the role type and the common name, as well as at least one of the digital identity certificate of the role, the Uniform Resource Locator address corresponding to the digital identity certificate, the on-chain account address of one or more of the at least one role, the smart contract address, the minter address and the pre-determined NFT token ID.

11. The method of claim 1, wherein the digital identity certificate of the role is a CA signed certificate which is returned to the role by a Certificate Authority CA in response to a Certificate Signing Request from the role.

12. The method of claim 1, wherein the signature by each of the at least one role is combined with the metadata, or an access address of the signature by each of the at least one role is included in the metadata.

13. The method of claim 1, wherein the signature by each of the at least one role is accessible via the metadata either directly or indirectly, or the signature is provided on demand.

14. A method for verifying a role associated with an NFT, comprising:
obtaining an NFT on chain,
acquiring metadata of the NFT based on the NFT, wherein the metadata includes a role type of at each of least one role associated with the NFT and a common name corresponding to the role type,
acquiring a digital identity certificate of each of the at least one role and a signature of the metadata by the role, and
verifying the signature of the metadata by the role by using the digital identity certificate of the role, and determining that the role type and the corresponding common name included in the metadata are authentic if the verification succeeds.

15. An apparatus for minting an NFT comprising:
an acquiring module configured to acquire metadata of an NFT to be minted, wherein the metadata includes a role type of each of at least one role associated with the NFT to be minted and a common name corresponding to the role type,
a signing module configured to allow each of the at least one role to sign the metadata by using a private key that corresponds to a public key contained in a digital identity certificate of the role, to obtain a signature by the role; and
a minting module configured to mint an NFT on chain based on the metadata.

16. An apparatus for verifying a role associated with an NFT, comprising:
a first obtaining module configured to obtain an NFT on chain, and obtain metadata of the NFT based on the NFT, wherein the metadata includes a role type of each of at least one role associated with the NFT and a common name corresponding to the role type,
a second obtaining module configured to acquire a digital identity certificate of each of the at least one role and a signature of the metadata by the role, and
a verifying module configured to verify the signature of the metadata by the role by using the digital identity certificate of the role, and to determine that the role type and the corresponding common name included in the metadata are authentic if the verification succeeds.

17. An electronic device comprising a processor, a storage device and a bus, wherein the storage device is stored with machine-readable instructions executable by the processor, the processor is in communication with the storage device via the bus when the electronic device operates, and the machine-readable instructions, when executed by the processor, perform the method for minting an NFT of claim 1.

18. An electronic device comprising a processor, a storage device and a bus, wherein the storage device is stored with machine-readable instructions executable by the processor, the processor is in communication with the storage device via the bus when the electronic device operates, and the machine-readable instructions, when executed by the processor, perform the method for verifying a role associated with an NFT of claim 14.

19. A computer readable storage medium stored with a computer program, which, when executed by a processor, performs the method for minting an NFT of claim 1.

20. A computer readable storage medium stored with a computer program, which, when executed by a processor, performs the method for verifying a role associated with an NFT of claim 14.
